(19) United States
(12) Patent Application Publication
(10) Pub. No.: US 2017/0288852 A1
(43) Pub. Date: Oct. 5, 2017

(54) OVERLAY COMMUNICATION IN OFDM-BASED NETWORKS

(71) Applicant: National Taiwan University, Taipei City (TW)

(72) Inventors: Chun-Ting CHOU, Taipei City (TW); Wei-Chen WANG, Taipei City (TW)

(73) Assignee: National Taiwan University, Taipei City (TW)

(21) Appl. No.: 15/468,850

(22) Filed: Mar. 24, 2017

(30) Foreign Application Priority Data
Mar. 30, 2016 (TW) 105109965

(51) Int. Cl. H04L 7/04; H04L 27/26

(52) U.S. Cl. CPC H04L 7/042; H04L 27/2678; H04L 27/2613

(57) ABSTRACT

A communication method is to be performed by a secondary transceiver. The secondary transceiver is operatively associated with a primary transceiver. The primary transceiver is configured to transmit an orthogonal frequency division multiplexing (OFDM) signal that has consecutive OFDM symbols. The OFDM symbol has a fixed OFDM symbol length and includes a cyclic prefix that has a fixed prefix length. The communication method includes steps of: A) upon receipt of the OFDM signal, determining a starting position of the cyclic prefix; and B) transmitting a to-be-transmitted signal during a time corresponding to the cyclic prefix of the one of the OFDM symbols or another one of the OFDM symbols subsequent to the one of the OFDM symbols.

### CROSS-REFERENCE TO RELATED APPLICATION

This application claims priority of Taiwanese Patent Application No. 105109965, filed on Mar. 30, 2016.

### FIELD

The disclosure relates to a communication method.

### BACKGROUND

Due to limited wireless spectrum, it is very important to reutilize the same spectrum if possible. Wireless spectrum is divided into licensed bands and unlicensed bands. The licensed bands are for use by users with a license. In order to solve the problem of increasingly scarce spectrum resources, the Federal Communications Commission (FCC) announced in 2010 that an unlicensed user may access a specific licensed band (e.g., UHF television band) dynamically under the condition that the unlicensed user does not affect use by the licensed users of the band. Thus, technology of dynamic spectrum access (DSA) is developed for unlicensed users to effectively utilize spectrum resources.

Dynamic spectrum access has its limitations. First, the unlicensed user needs to know the presence of the licensed user on the band and avoid interfering with the licenseduser, i.e., detect-and-avoid (DAA). Second, once the licensed user returns to the licensed band, the unlicensed user is forced to stop transmission on the licensed band, and thus the quality of service (QOS) is degraded.

### SUMMARY

Therefore, an objective of this disclosure is to provide a communication method that can alleviate at least one drawback of the prior art.

According to the disclosure, a communication method is to be performed by a secondary transceiver. The secondary transceiver is collocated in terms of operating frequency with a primary transceiver. The primary transceiver is configured to transmit at a predetermined band an orthogonal frequency division multiplexing (OFDM) signal that has a plurality of consecutive OFDM symbols. Each of the OFDM symbols has a fixed OFDM symbol length and includes a cyclic prefix that has a fixed pre fix length. The communication method includes steps of: A) upon reception of the OFDM signal, determining a starting position of the cyclic prefix of one of the OFDM symbols of the OFDM signal; and B) transmitting a to-be-transmitted signal during a time corresponding to the cyclic prefix of the one of the OFDM symbols or another one of the OFDM symbols subsequent to the one of the OFDM symbols.

### BRIEF DESCRIPTION OF THE DRAWINGS

Other features and advantages of the disclosure will become apparent in the following detailed description of the embodiment (s) with reference to the accompanying drawings, of which:

FIG. 1 is a schematic diagram illustrating a primary transceiver and a secondary transceiver according to the disclosure;

FIG. 2 is a diagram illustrating an OFDM signal transmitted by the primary transceiver;

FIG. 3 is a flow chart illustrating an embodiment of a communication method according to this disclosure;

FIG. 4 is a diagram illustrating the OFDM signal and a pulse signal having an initial period and an initial pulse width;

FIG. 5 is a diagram illustrating the OFDM signal and the pulse signal having an adjusted period and an adjusted pulse width;

FIG. 6 is a flow chart illustrating sub-steps of step 50 of FIG. 3; and

FIGS. 7, 8 and 9 are diagrams cooperatively illustrating exemplary waveforms of relevant signals and parameters involved in the sub-steps of FIG. 6.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

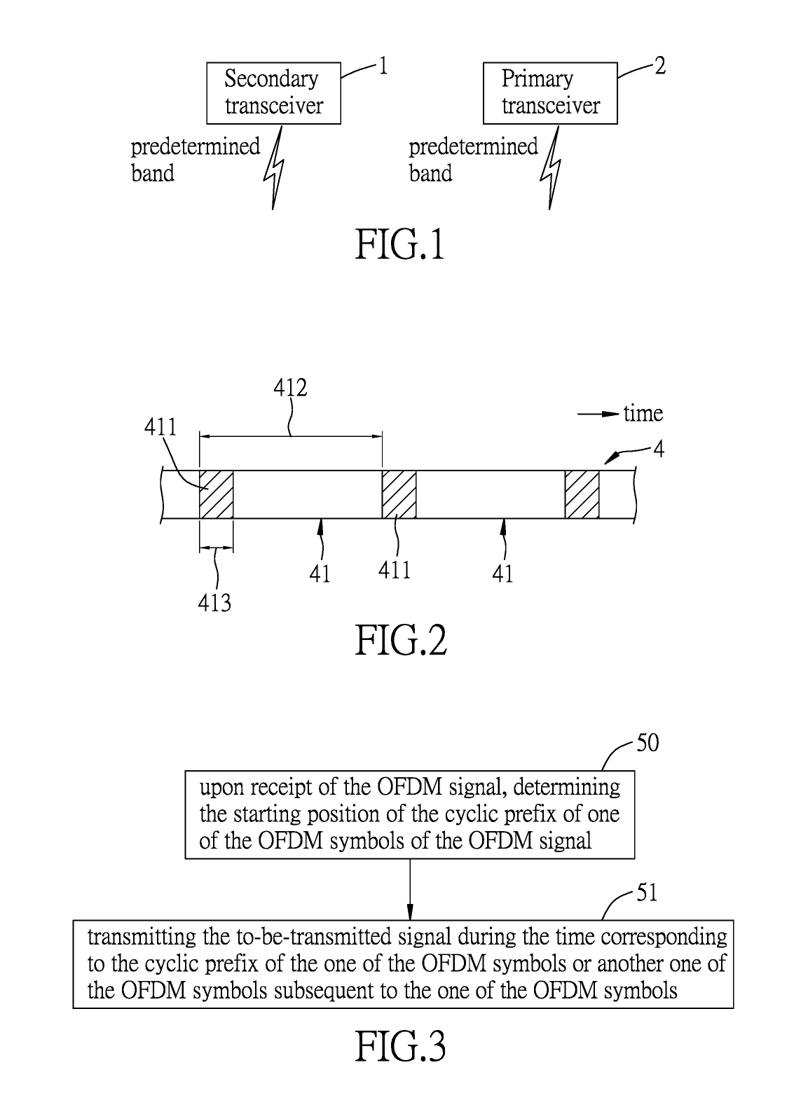

FIG. 1 shows a secondary transceiver 1 and a primary transceiver 2 capable of transmitting signals at the same predetermined band. An embodiment of a communication method according to this disclosure is to be performed by the secondary transceiver 1. The secondary transceiver 1 is collocated in terms of operating frequency with a primary transceiver 2. The primary transceiver 2 is configured to transmit at the predetermined band an orthogonal frequency division multiplexing (OFDM) signal 4 (see FIG. 2).

Referring to FIG. 2, the OFDM signal 4 has a plurality of consecutive OFDM symbols 41. Each of the OFDM symbols 41 has a fixed OFDM symbol length 412 and includes a cyclic prefix 411 that has a fixed prefix length 413. The fixed OFDM symbol length 412 and the fixed prefix length 413 are known parameters to the secondary transceiver 1.

It is noted that the communication method could be categorized as overlay communication in OFDM-based networks.

Referring to FIG. 3, the communication method includes step 50 and step 51. In step 50, upon reception of the OFDM signal 4, the secondary transceiver 1 determines a starting position of the cyclic prefix 411 of one of the OFDM symbols 41 of the OFDM signal 4. In step 51, the secondary transceiver 1 transmits a to-be-transmitted signal during a time corresponding to the cyclic prefix 411 of the one of the OFDM symbols 41 or another one of the OFDM symbols 41 subsequent to the one of the OFDM symbols 41.

In bulk, the purpose of step 50 is for the secondary transceiver 1 to determine the exact timing positions of the cyclic prefixes 411 of the OFDM signal 4.

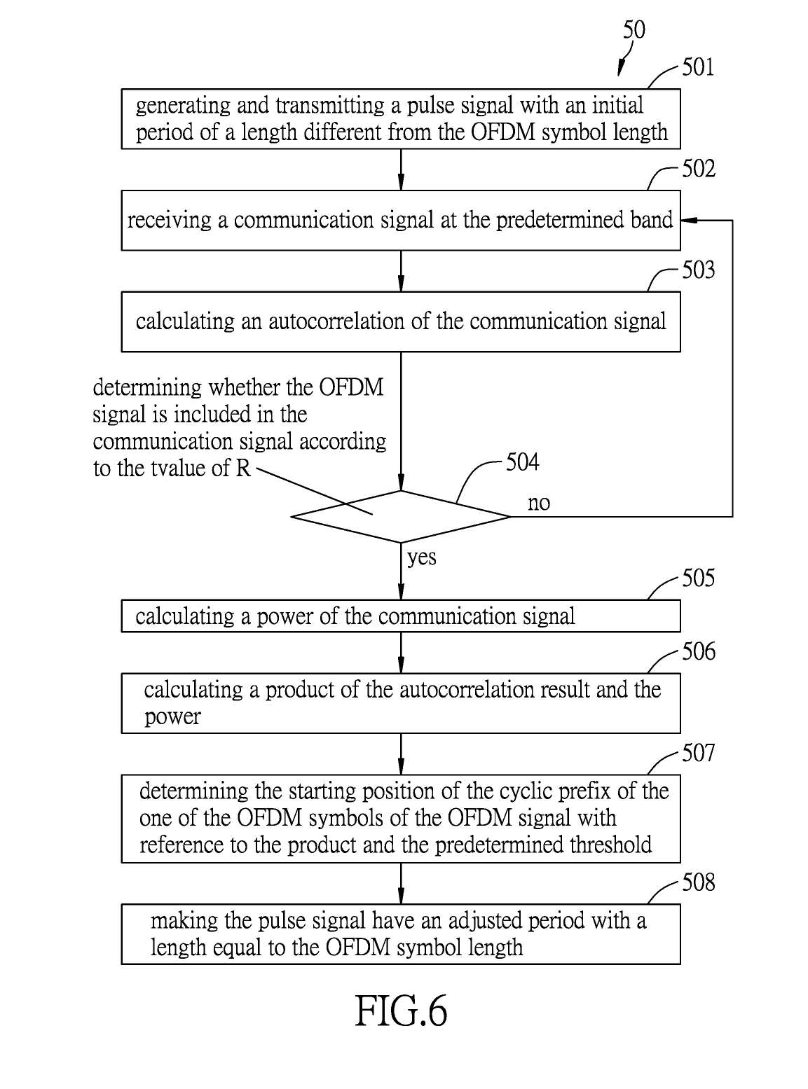

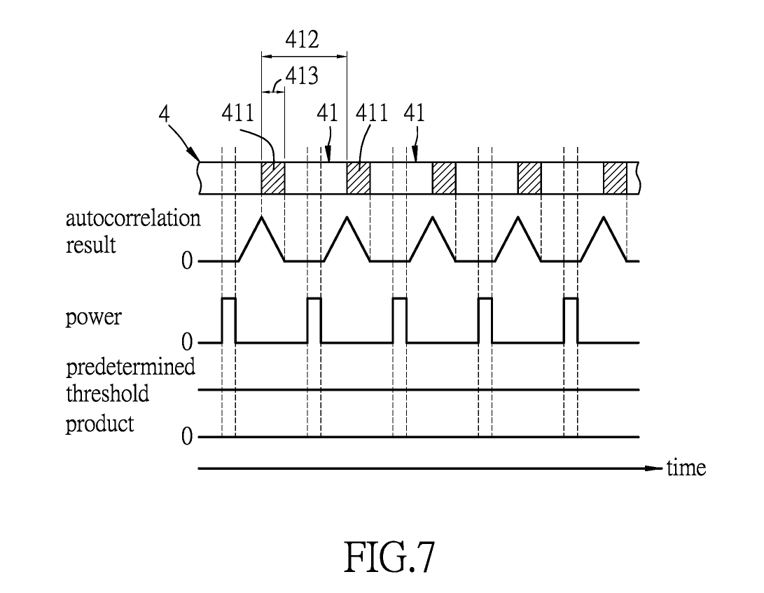

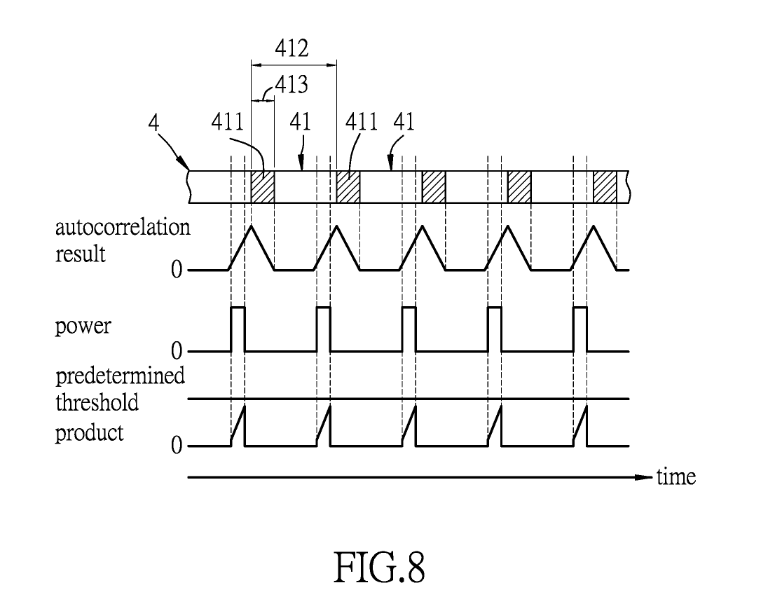

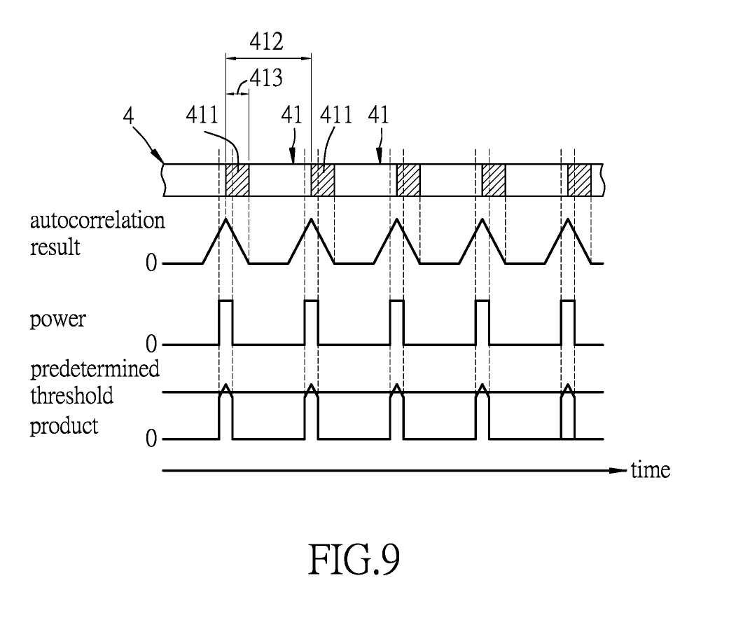

Referring to FIGS. 6 to 9, in particular, step 50 may include the following sub-step 501 to sub-step 508.

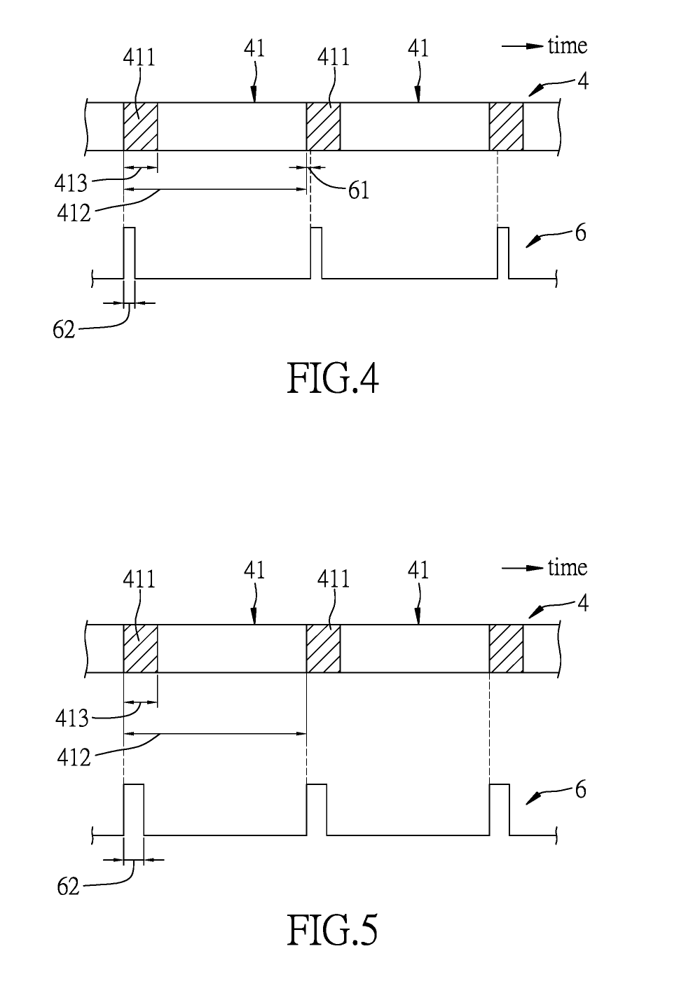

In sub-step 501, further referring to FIG. 4, the secondary transceiver 1 generates and transmits a pulse signal 6 having an initial period with a length that is slightly different from the OFDM symbol length 412. Herein, the length of the initial period of the pulse signal 6 is equal to a summation of the OFDM symbol length 412 and a predetermined length 61. An initial pulse width 62 of the pulse signal 6 is not greater than the prefix length 413 of each cyclic prefix 411. In an example, the predetermined length 61 is greater than zero and smaller than 0.167 μs, and the initial pulse width 62 is greater than zero and smaller than 34.3/298 of the prefix length 413.

In sub-step 502, the secondary transceiver 1 receives a communication signal at the predetermined band. The communication signal includes at least the pulse signal 6.

In sub-step 503, the secondary transceiver 1 calculates an autocorrelation of the communication signal. The autocorrelation is calculated by the equation:

$$R ( n ) - {\sum }_{n = i}^{i + {N}_{CP} - 1} S ( n ) \cdot {S}^{*} ( n + {N}_{FFT} )$$

, wherein R is the result of the autocorrelation, S is the received signal, N_{CP} is a size of the fixed cyclic prefix length 413, and N_{FET} is a size of Fast Fourier Transform (FFT) of the OFDM symbols 41.

In sub-step 504, the secondary transceiver 1 determines whether the OFDM signal 4 is included in the communication signal according to the value of R. In detail, sub-step 504 includes determining whether a period of the autocorrelation result is equal to the OFDM symbol length 412 in order to determine whether the OFDM signal 4 is included in the communication signal. If the period of the autocorrelation result is equal to the OFDM symbol length 412, it is determined that the OFDM signal 4 is included in the communication signal. This means that the primary transceiver 1 has transmitted (or is transmitting) the OFDM signal 4, and the flow goes to sub-step 505. Otherwise, the primary transceiver 1 has not transmitted (or is not transmitting) the OFDM signal 4, and the flow goes back to sub-step 502.

In sub-step 505, the secondary transceiver 1 calculates a power of the communication signal. It is noted that in this embodiment, sub-step 505 is performed after sub-step 503 and sub-step 504. However, in other embodiments, sub-step 505, and sub-steps 503 and 504 might be performed at the same time, or sub-step 505 may be performed before sub-steps 503 and 504.

In sub-step 506, the secondary transceiver 1 calculates a product of the autocorrelation result and the power.

In sub-step 507, the secondary transceiver 1 determines the starting position of the cyclic prefix 411 of the one of the OFDM symbols 41 of the OFDM signal 4 with reference to the product and a predetermined threshold. In detail, sub-step 507 includes comparing the product and the predetermined threshold. When the product is greater than the predetermined threshold, the secondary transceiver 1 determines a point where the product is greater than the predetermined threshold to be the starting position of the cyclic prefix 411 of the one of the OFDM symbols 41 of the OFDM signal 4 (i.e., a point where a rising edge of the pulse signal 6 is aligned with the starting point of the cyclic prefix 411 of the one of the OFDM symbols 41 of the OFDM signal 4).

In sub-step 508, once the starting position is determined in sub-step 507, referring to FIG. 5, the secondary transceiver 1 makes the pulse signal 6 have an adjusted period with a length equal to the OFDM symbol length 412 so as to synchronize subsequent rising edges of the pulse signal 6 with the starting positions of the cyclic prefixes 411 of the OFDM symbols 41 of the OFDM signal 4 subsequent to the one of the OFDM symbols 41. The secondary transceiver 1 further makes the pulse signal 6 have an adjusted pulse width 62 (FIG. 5) greater than the initial pulse width 62 (FIG. 4) of the pulse signal 6 that has the initial period and not greater than the prefix length 413. In one example, the adjusted pulse width 62 (FIG. 5) is smaller than 243/298 of the fixed prefix length 413. In another example, the adjusted pulse width 62 may be greater or equal to 243/298 of the fixed prefix length 413, but still smaller than the fixed prefix length 413. With the length of the initial period of the pulse signal 6 being set to be different from the OFDM symbol length 412, the pulses of the pulse signal 6 will gradually move into or away from the cyclic prefixes of the OFDM signal 4. The product of the autocorrelation and the power is able to indicate the starting point of acyclic prefix 411 with reference to the predetermined threshold. For instance, the autocorrelation result may be a triangular wave with periodic peaks thereof corresponding to the starting positions of the cyclic prefixes 411 of the OFDM signal 4, and the power of the pulse signal 6 maybe a pulsating signal having the same period and pulse width as the pulse signal 6. When the pulses of the pulse signal 6 do not coincide at all with the cyclic prefixes 411 of the OFDM signal 4 in time, the product would be a flat curve, and when the pulses start to coincide with the cyclic prefixes 41 in time, the product begins to approach the predetermined threshold until surpassing the same, at which time the secondary transceiver 1 adjusts the period of the pulse signal 6 and the pulse width 62 to complete synchronization of the pulse signal 6 with the OFDM signal 4.

In step 51, in this embodiment, the secondary transceiver 1 transmits the to-be-transmitted signal during a duration with the adjusted width 62.

It is noted that the power of the to-be-transmitted signal should be high enough for a receiving terminal to receive and decode successfully the to-be-transmitted signal. In this embodiment, the power of the to-be-transmitted signal after being transmitted through a channel and received by a receiving terminal is greater by at least 20 dB and at most 30 dB than the power of the OFDM signal 4 after being transmitted through the channel and received by the receiving terminal. But this disclosure is not limited to this configuration. In another embodiment, if the power of the pulse signal 6 after being transmitted through a channel and received by a receiving terminal is greater by 30 dB than the power of the OFDM signal 4 after the same is transmitted through the channel and received by the receiving terminal, then the pulse width 62 is limited to a maximum of 77/100 of the fixed prefix length 413.

In sum, in the presence of the OFDM signal 4, the secondary transceiver 1 is able to determine a starting position of the cyclic prefix 411 of one of the OFDM symbols 41 of the OFDM signal 4 by sending a pulse signal. The secondary transceiver 1 is able to transmit a to-be-transmitted signal with a high-enough power during a time corresponding to the cyclic prefix 411 of at least one of the OFDM symbols 41 of the OFDM signal 4. Thus, the secondary transceiver 1 can share the predetermined band with the primary transceiver 2 without affecting transmission on the predetermined band by the primary transceiver 2.

In the description above, for the purposes of explanation, numerous specific details have been set forth in order to provide a thorough understanding of the embodiment(s). It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A communication method to be performed by a secondary transceiver, the secondary transceiver being collocated in terms of operating frequency with a primary transceiver, the primary transceiver being configured to transmit at a predetermined band an orthogonal frequency division multiplexing (OFDM) signal that has a plurality of consecutive OFDM symbols, each of the OFDM symbols having a fixed OFDM symbol length and including a cyclic prefix that has a fixed prefix length, said communication method comprising steps of:
A) upon receipt of the OFDM signal, determining a starting position of the cyclic prefix of one of the OFDM symbols of the OFDM signal; and
B) transmitting a to-be-transmitted signal during a time corresponding to the cyclic prefix of said one of the OFDM symbols or another one of the OFDM symbols subsequent to said one of the OFDM symbols.

2. The communication method as claimed in claim 1, wherein step A) includes sub-steps of:
A1) generating and transmitting a pulse signal having an initial period with a length that is different from the OFDM symbol length;
A2) receiving a communication signal at the predetermined band, the communication signal including at least the pulse signal;
A3) calculating an autocorrelation of the communication signal;
A4) determining whether the OFDM signal is included in the communication signal according to result of the autocorrelation;
A5) calculating a power of the communication signal;
A6) calculating a product of the result of the autocorrelation and the power when it is determined that the OFDM signal is included in the communication signal; and
A7) determining the starting position of the cyclic prefix of said one of the OFDM symbols of the OFDM signal with reference to the product and a predetermined threshold.

3. The communication method as claimed in claim 2, wherein in sub-step A1), the length of the initial period of the pulse signal is equal to a summation of the OFDM symbol length and a predetermined length.

4. The communication method as claimed in claim 2, wherein sub-step A7) includes
comparing the product and the predetermined threshold, and
when the product is greater than the predetermined threshold, determining a point where the product is greater than the predetermined threshold to be the starting position of the cyclic prefix of said one of the OFDM symbols of the OFDM signal.

5. The communication method as claimed in claim 2, wherein sub-step A4) includes determining whether a period of the result of autocorrelation is equal to the OFDM symbol length in order to determine whether the OFDM signal is included in the communication signal.

6. The communication method as claimed in claim 2, wherein step A) further includes a sub-step of:
A8) once the starting position is determined in sub-step A7), making the pulse signal have an adjusted period with a length equal to the OFDM symbol length so as to synchronize subsequent rising edges of the pulse signal with the starting positions of the cyclic prefixes of the OFDM symbols of the OFDM signal subsequent to said one of the OFDM symbols.

7. The communication method as claimed in claim 6, wherein in step B), the to-be-transmitted signal is transmitted during a pulse duration of at least one pulse of the pulse signal that has the adjusted period.

8. The communication method as claimed in claim 7, wherein step A) further includes a sub-step of making the pulse signal that has the adjusted period have a pulse width greater than a pulse width of the pulse signal that has the initial period and not greater than the prefix length.

9. The communication method as claimed in claim 2, wherein a pulse width of the pulse signal generated in sub-step A1) is not greater than the prefix length.
